(19) United States
(12) Patent Application Publication
(10) Pub. No.: US 2007/0203829 A1
(43) Pub. Date: Aug. 30, 2007

(54) System and methods for transmitting funds and instituting loans

(76) Inventor: Charles Polanco, Matthews, NC (US)

Correspondence Address: PILLSBURY WINTHROP SHAW PITTMAN, LLP, P.O. BOX 10500, MCLEAN, VA, 22102, US

(21) Appl. No.: 11/180,486

(22) Filed: Jul. 13, 2005

(51) Int. Cl. G06Q 40/00

(52) U.S. Cl. 705/39

(57) ABSTRACT

A combination money transmitter and loan system includes a central computer having a processor and a memory. Multiple user accounts are stored in the memory, each having a unique user identifier and a user balance indicative of a monetary balance value. A loan database stores a loan amount, a loan term, and an interest rate. Using the processor, a calculator program calculates a periodic repayment amount based upon the loan amount, the loan term, the interest rate, and stores the periodic repayment amount in the loan database. During a loan process, a money transmitter program transmits funds from the user balance of a first user to the user balance of a second user using the unique user identifier of the second user. Subsequently the periodic repayment amount is periodically transmitted from the user balance of the second user to the user balance of the first user.

### CROSS-REFERENCE TO RELATED APPLICATIONS

Not Applicable

### STATEMENT REGARDING FEDERALLY SPONSORED RESEARCH

Not Applicable

### BACKGROUND OF THE INVENTION

1. Field of the Invention

This invention relates generally to electronic finds transaction systems and methods, and more particularly to systems and methods for electronically transmitting funds and simultaneously instituting a loan.

2. Description of Related Art

The Internet is a global network including millions of connected computers. The World Wide Web (i.e., the “Web”) is a portion of the Internet that supports electronic documents formatted in the HyperText Markup Language (HTML). HTML advantageously supports links to other electronic documents, enabling users to transition between electronic documents simply by activating links. The Internet and the Web have spurred development of electronic (i.e., “on-line”) banking and funds transfer systems such as bill paying systems.

The Internet has also enabled money transmitter services such as PAYPAL® and similar services. These money transmitter services enables users to transmit money between users, merchants, and any other parties or entities, with the click of a mouse. The money transmitter services enables users to direct money to an email account or similar identifier, making money transmissions both fast and easy.

The prior art teaches money transmitter systems. However, the prior art does not teach a money transmitter system that enables a user to transmit money as a loan, and then functions to track the loan and automatically execute repayment of the loan with money transmissions back from the borrower to the lender. The present invention fulfills these needs and provides further related advantages as described in the following summary.

### SUMMARY OF THE INVENTION

The present invention teaches certain benefits in construction and use which give rise to the objectives described below.

The present invention provides a combination money transmitter and loan system that includes a central computer having a processor and a memory. Multiple user accounts are stored in the memory, each having a unique user identifier and a user balance indicative of a monetary balance value. A loan database stores a loan amount, a loan term, and an interest rate. Using the processor, a calculator program calculates a periodic repayment amount based upon the loan amount, the loan term, the interest rate, and stores the periodic repayment amount in the loan database. During a loan process, a money transmitter program transmits funds from the user balance of a first user to the user balance of a second user using the unique user identifier of the second user. Subsequently the periodic repayment amount is periodically transmitted from the user balance of the second user to the user balance of the first user.

A primary objective of the present invention is to provide a combination money transmitter and loan system having advantages not taught by the prior art.

Another objective is to provide a combination money transmitter and loan system that enables a user to transmit money as a loan, and then functions to track the loan and automatically execute repayment of the loan with money transmissions back from the borrower to the lender.

A further objective is to provide a combination money transmitter and loan system that automates collections efforts in the event that the loan cannot be repaid.

Other features and advantages of the present invention will become apparent from the following more detailed description, taken in conjunction with the accompanying drawings, which illustrate, by way of example, the principles of the invention.

### BRIEF DESCRIPTION OF THE DRAWING

The accompanying drawings illustrate the present invention. In such drawings:

FIG. 1 is a diagram of one embodiment of a system for transmitting monetary funds and for instituting monetary loans;

FIG. 2 shows a displayed image of one embodiment of a user account information electronic document;

FIG. 3 shows a displayed image of one embodiment of a loan offer electronic document;

FIG. 4 shows a displayed image of the user account information electronic document of FIG. 2 following institution of a loan initiated using the loan offer electronic document of FIG. 3; and

FIG. 5 is a flowchart of one embodiment of a method for instituting a loan between users of the system of FIG. 1.

### DETAILED DESCRIPTION OF THE INVENTION

The above-described drawing figures illustrate the invention, a system 10 for transmitting monetary funds and for simultaneously creating and tracking a loan.

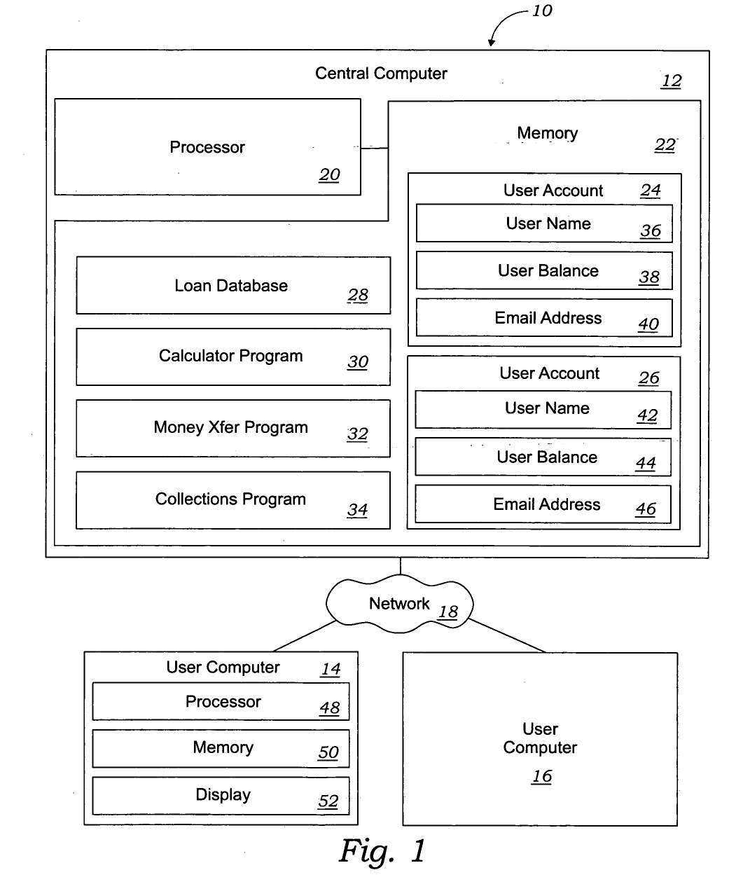

FIG. 1 is a diagram of one embodiment of the system 10, including a central computer 12 and two user computers 14 and 16 coupled to a network 18. The central computer 12 and the user computers 14 and 16 communicate via the network 18. In general, the network 18 is a communication network, and may include, for example, a local area network (LAN), a wide area network (WAN), a public switched telephone network (PSTN), and/or the Internet. The connection may be continuous, or sporadic, as is well known in the art. The central computer 12 is configured to provide electronic documents, including hypertext markup language (HTML) electronic documents, in response to requests from the user computers 14 and 16. Since such networks and their use are well known, they are not described in greater detail herein.

The central computer 12 includes a processor 20 coupled to a memory 22. Stored in the memory 22 are two user accounts 24 and 26, a loan database 28, a calculator program 30, a money transmitter program 32, and a collections program 34. The user account 24 includes user name information 36, user balance information 38, and email address information 40. In general, the user name information 36 is indicative of a name of a user owning the user account 24, the user balance information 38 is indicative of a monetary balance value of the user account 24, and the email address information 40 is indicative of an email address of the user owning the user account 24.

Similarly, the user account 26 includes user name information 42, user balance information 44, and email address information 46. In general, the user name information 42 is indicative of a name of another user owning the user account 26, the user balance information 44 is indicative of a monetary balance value of the user account 26, and the email address information 46 is indicative of an email address of the other user owning the user account 26.

In the embodiment of FIG. 1, the email address information 40 serves as a unique user identifier that uniquely identifies the user owning the user account 24, and the email address information 46 serves as a unique user identifier that uniquely identifies the other user owning the user account 26. It is noted that other unique identifiers for uniquely identifying users are possible and may be used.

While the user accounts 24 and 26 are preferably special accounts that may be maintained by the money transmitter, the user accounts 24 and 26 may also be traditional bank accounts maintained at a bank. These user accounts 24 and 26 could be identified by a bank account number, as is currently well known, and the system 10 could facilitate loans by bank transfers between the banking customers.

In general, the loan database 28 is used to store information regarding loans instituted within the system 10. Such loan information includes loan amounts, loan terms, and interest rates.

The calculator program 30 includes software (i.e., computer instructions) for causing the processor 20 to calculate a periodic repayment amount for each instituted loan, and to store the periodic repayment amount in the loan database 28. In general, the calculator program 30 calculates the periodic repayment amount based upon a selected loan amount, a selected loan term, and a selected interest rate.

The money transmitter program 32 includes software (i.e., computer instructions) for causing the processor 20 to transmit funds from a user balance of one user account to the user balance of another user account. As described below, the money transmitter program 32 may also be used to transmit funds between a user account and other accounts linked to the user account. A money transmitter process carried out by the money transmitter program 32 is initiated by the owner of a user account having sufficient funds. In one embodiment, the initiating user account owner specifies an email address of an intended recipient of the funds, and the money transmitter program 32 uses the email address information to direct the transmission to the other user account.

For loans instituted within the system 10, the money transmitter program 32 also periodically and automatically transmits funds, in the amounts of the calculated periodic repayment amounts, from lendee user accounts to corresponding lender user accounts. The money transmitter program 32 carries out these periodic transmissions until original loan amounts, plus interest, have been transmitted from user balances of lendee user accounts to user balances of corresponding lender user accounts.

The collections program 34 includes software (i.e., computer instructions) for causing the processor 20 to initiate certain actions in the event a loan instituted within the system 10 is not repayed according to the agreed upon terms. For example, the collections program 34 may be invoked by the money transmitter program 32 when attempting to carry out an automatic transmission of a periodic repayment amount resulting from a loan, and the user balance of the lendee user account indicates the lendee user account has insufficient funds. In one embodiment, a collection option is selected by a lender at the time a loan offer is made. Exemplary collection options include: (i) email reminder only, (ii) email reminder followed by sending the matter to collections (e.g., a collection agency), and (iii) sending the matter directly to collections. When invoked, the collections program 34 may access the loan database 28 to determine the selected collection option, then carry out the selected collection option.

In the embodiment of FIG. 1, the user computer 14 includes a processor 48, a memory 50, and a display 52. In a preferred embodiment, the display 52 is a computer monitor. The user computer 16 preferably also has a processor, a memory, and a display.

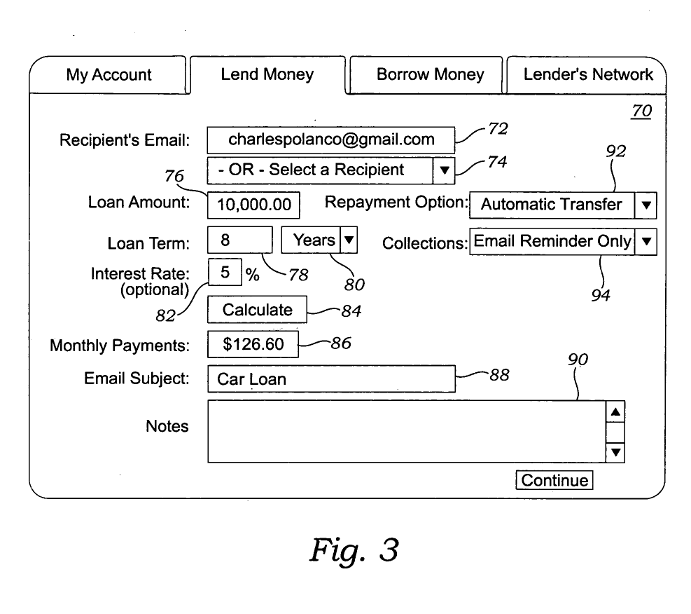

In the embodiment of FIG. 1, the user computer 14 belongs to a first user having a user account within the system 10, and the user computer 16 belongs to a second user also having a user account within the system 10. The first user may initiate a loan offer to the second user by requesting a loan offer electronic document (see FIG. 3) from the central computer 12 via the network 18. In response to the request, the central computer 12 may provide a blank loan offer electronic document to the first user via the network 18. The user computer 14 may display the received blank loan offer electronic document on the display 52.

Using one or more input devices of the user computer 14, the first user may input a loan amount, a loan term, an interest rate, and repayment intervals in the loan offer electronic document while the loan offer electronic document is displayed on the display 52. When finished, the first user may submit the completed loan offer electronic document to the central computer 12 via the network 18.

When the central computer 12 receives the completed loan form via the network 18, the central computer 12 may send the second user a message notifying the user of the pending loan offer within the system 10. For example, the first user may provide an email address of the second user, and the central computer 12 may send the second user an email message notifying the user of the pending loan offer.

When the second user receives the message from the central computer 12, the second user may access the central computer 12 and request information regarding the loan offer. In response to the request, the central computer 12 may generate and send the second user a second loan offer electronic document that specifies the loan amount, the loan term, the interest rate, and the repayment intervals.

The user computer 16 may receive the second loan offer electronic document from the central computer 12, and may display the second loan offer electronic document on the display. The second user may review the displayed loan information, and either accept or reject the pending loan offer. For example, the second loan offer electronic document may include an “ACCEPT” button and a “REJECT” button. The second user may accept the loan offer by activating the ACCEPT button, or reject the loan offer by activating the REJECT button.

If the second user accepts the pending loan offer, the central computer 12 may store the loan amount, the loan term, the interest rate, and the repayment interval, all specified by the first user (i.e., the lender) and agreed to by the second user (i.e., the lendee), in the loan database 28 of the central computer 12 of FIG. 1.

It is noted that by virtue of using email messages to notify prospective recipients of loan offers, the second user need not have a user account within the system 10 when the loan offer is made. For example, if the second user does not have a user account within the system 10 when the central computer 12 notifies the second user of the pending loan offer via email, the second user may create a user account within the system 10 before accepting the pending loan offer.

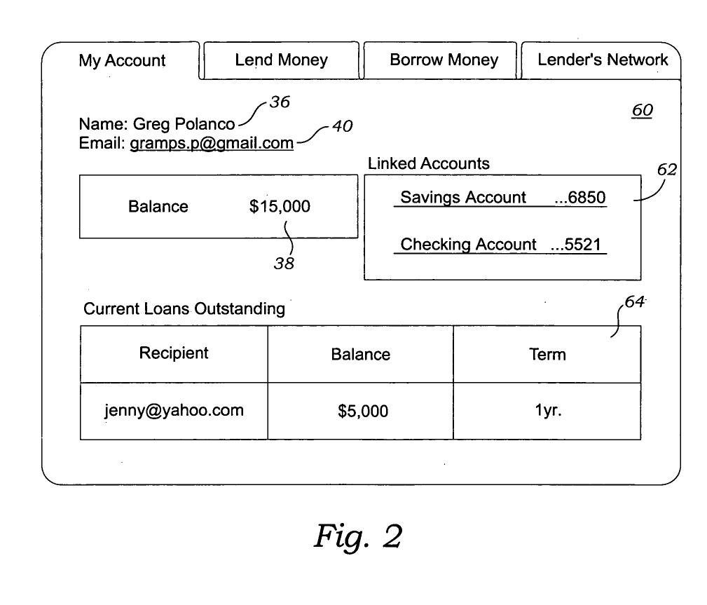

FIG. 2 shows a displayed image of one embodiment of a user account information electronic document 60. In the embodiment of FIG. 2, the user account information electronic document 60 is part of a Web page generated by the central computer 12 of FIG. 1 and transmitted to a user computer for display. In FIGS. 2-4, the user account 24 of FIG. 1 is owned by a user named “Greg Polanco,” and the user account information electronic document 60 includes information about the user account 24. The user account information electronic document 60 includes the user name information 36 of FIG. 1, wherein the user name information 36 is “Greg Polanco.” The user account information electronic document 60 also includes the email address information 40 of FIG. 1, wherein the email address information 40 is “Gramps_P@gmail.com.” The user account information electronic document 60 of FIG. 2 also includes the user balance information 38 of FIG. 1, wherein the user balance information 38 is “$15,000.”

The user account information electronic document 60 also includes a list of linked accounts 62 and a list of outstanding loans 64. In general, the list of linked accounts 62 includes information identifying other accounts linked to the user account owned by the user named “Greg Polanco” (i.e., to the user account 24 of FIG. 1). The list of linked accounts 62 includes a savings account numbered, in part, “6850” and a checking account numbered, in part, “5521.” As described above, the money transmitter program 32 of FIG. 1 may be used to transmit funds between the user account 24 and any of the linked accounts in the list of linked accounts 62. Thus the money transmitter program 32 of FIG. 1 may be used to transmit funds between the user account 24, the savings account numbered “6850,” and/or the checking account numbered “5521.”

In general, the list of outstanding loans 64 includes information about loans initiated by the user “Greg Polanco” and subsequently instituted within the system 10. In FIG. 2 the list of outstanding loans 64 includes information regarding a loan to another user having an email address “jenny@yahoo.com.” The loan has an outstanding balance of “$5,000” and a term of “1 yr.” This information indicates that the user “Greg Polanco” loaned the other user with the email address “jenny@yahoo.com” a sum of money. The loan is to be repaid over the term “1 yr.” and the outstanding balance is currently “$5,000.”

Of course, those skilled in the art will recognize that the list of outstanding loans 64 might include a great deal of additional information, including more detailed terms of the loan, collection instructions, repayment history, and other information. The electronic document could also include a similar list of loans made to the user, in a similar manner as used to track loans made. Such obvious and/or anticipated modifications and additions should be considered within the scope of the claimed invention.

FIG. 3 shows a displayed image of one embodiment of a loan offer electronic document 70. In the embodiment of FIG. 3, the loan offer electronic document 70 is part of a Web page generated by the central computer 12 of FIG. 1 and transmitted to a user computer for display, although it could take other forms, including an emailed document, or other suitable form of transmission. As described above, the user “Greg Polanco” owns the user account 24 of FIG. 1 having the user account information shown in the user account information electronic document 60 of FIG. 2. In FIG. 3, the user “Greg Polanco” has modified the electronic document 70 to initiate a loan to a prospective recipient (i.e., lendee) having an email address “charlespolanco@gmail.com.”

In the embodiment of FIG. 3, the loan offer electronic document 70 includes a text box 72 labeled “Recipient's Email:” in which the user “Greg Polanco” has typed the email address “charlespolanco@gmail.com.” The loan offer electronic document 70 also has a drop down menu 74 that lists one or more email addresses the user has entered previously. In a text box 76 labeled “Loan Amount:,” the user has typed the value “10,000.00.” In a text box 78 labeled “Loan Term:,” the user has typed the value “8,” and in an adjacent drop down menu 80 the user has selected the option “Years.” The loan amount and the loan term can be any amounts that may be desired, from very large loan amounts payable over many years, to small loan amounts that may be paid off in mere days.

The loan offer electronic document 70 also includes a text box 82 labeled “Interest Rate:” in which the user “Greg Polanco” has typed the value “5.” A button 84 labeled “Calculate” is activated by the user to invoke the calculator program 30 of FIG. 1. In response to the user activating the button 84 labeled “Calculate,” the calculator program 30 has inserted the amount “$126.60” in a text box 86 labeled “Monthly Payments:,” wherein the amount $126.60 is the periodic repayment amount calculated by the calculator program 30. In a text box 88 labeled “Email Subject:” the user has typed the phrase “Car Loan.” As a result, the central computer 12 uses the phrase “Car Loan” as the subject of the email message to the prospective recipient to inform the prospective recipient of the pending loan offer. A scroll box 90 is provided for the user to insert notes about the loan.

While many of the loans will carry at least a small interest rate, this is not required, and it is worth noting that the selected interest rate may be 0% in some cases. Also, while the present embodiment includes monthly payments, this could also be modified, either automatically or manually, to include payments quarterly, monthly, weekly, or even daily or hourly.

While the present loan is for $10,000, it should be understood that the system 10 functions for both large loans and small loans. The system 10 could just as easily be used to make loans of $100, $20, or even just a few dollars, with payment terms of weeks or even days.

Using a drop down menu 92 labeled “Repayment Option:” the user “Greg Polanco” has selected an option “Automatic Transfer.” The “Automatic Transfer” option indicates that the money transfer program 32 of FIG. 1 is to periodically and automatically transmit funds, in the amount of a calculated periodic repayment amount, from the user account of the recipient (i.e., the lendee) to the user account of the user making the loan (i.e., the lender). Those skilled in the art will recognize that a range of options are possible, including emailed invoices that allow the borrower to authorize the transmission of funds before it occurs, emailed reminders that require the borrower to actively make the funds transfer, and/or any other form of reminder system, electronic or otherwise.

In a drop down menu 94 labeled “Collections:” the user has selected the option “Email Reminder Only” indicating that in the event the recipient's user account has insufficient funds when an automatic transmission of the periodic repayment amount is to be carried out, the collections program 34 of FIG. 1 is to only send the recipient an email reminder. In the preferred embodiment, the options available under collections may include (i) email reminder only, (ii) email reminder followed by sending the matter to collections, or (iii) sending the matter directly to collections.

In other embodiments, other options might be available as well. For example, overdrafts on one account could result in drawing funds from other accounts such as checking or savings accounts. It is important to recognize that many various options could be devised by one skilled in the art, offering the user a range of possibilities, including customized actions, timetables, and alternatives, and the wide range of possible options should be considered within the scope of the present invention.

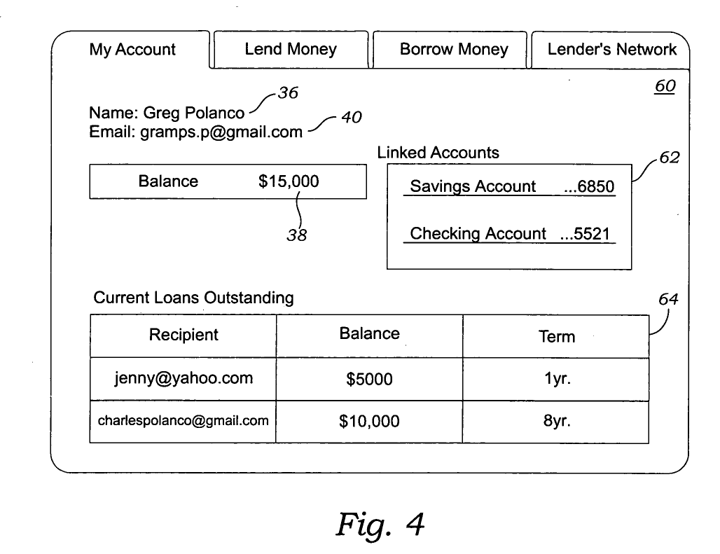

FIG. 4 shows a displayed image of the user account information electronic document 60 of FIG. 2 following institution of the loan initiated using the loan offer electronic document 70 lo of FIG. 3. In FIG. 4, the user balance information 38 of the user account 24 of FIG. 1, belonging to the user “Greg Polanco,” has been reduced to “$5,000” reflecting the $10,000 loan to the recipient (i.e., lendee) having the email address “charlespolanco@gmail.com.” (See FIG. 3.) That is, the user balance of the user account of the recipient having the email address “charlespolanco@gmail.com” has been increased by $10,000, and the user balance information 38 of the user account 24 of the user “Greg Polanco” has been reduced by $10,000. In addition, the list of outstanding loans 64 has been updated to include the loan to “charlespolanco@gmail.com” with a balance of “$10,000” and a term of “8 yr.” in addition to the loan to “jenny@(yahoo.com.” (See FIG. 2.)

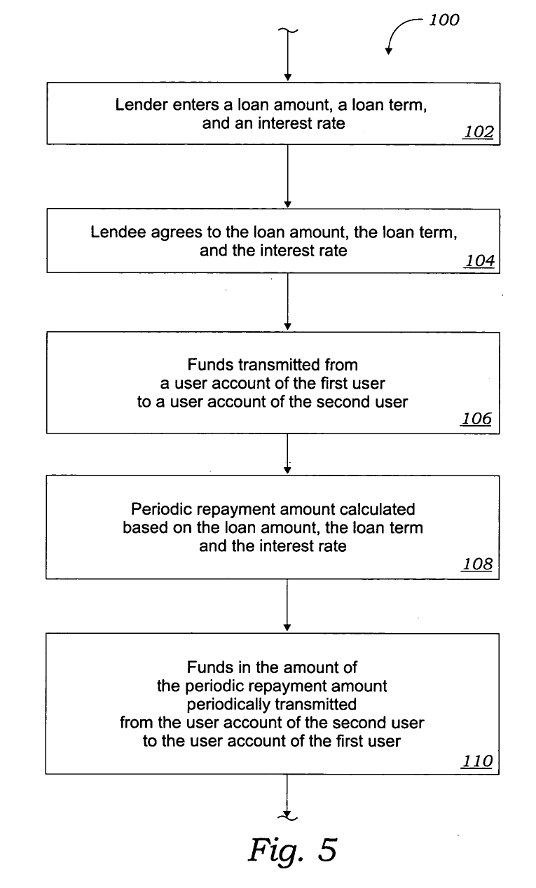

FIG. 5 is a flowchart of one embodiment of a method 100 for instituting a loan between users of the system 10 of FIG. 1. In a step 102 of the method 100, a first user of the system 10 (i.e., the lender) enters a loan amount, a loan term, and an interest rate. This may be accomplished via a loan offer electronic document (e.g., the loan offer electronic document 70 of FIG. 3) as described above. A second user of the system 10 (i.e., the recipient or lendee) agrees to the loan amount, the loan term, and the interest rate during a step 104. This may be accomplished via another loan offer electronic document as described above

During a step 106, funds are transmitted from a user account of the first user (e.g., the user account 24 of FIG. 1) to a user account of the second user (e.g., the user account 26 of FIG. 1). In general, a unique user identifier of the second user is used to direct the funds transmission. As described above, in one embodiment the unique user identifier of the second user is an email address of the second user. During the funds transmission, the user balance of the user account of the first user is reduced by the amount of the funds transmitted, and the user balance of the user account of the second user is increased by the amount of the finds transmitted.

A periodic repayment amount is calculated during a step 108 based upon the loan amount, the loan term, and the interest rate. The calculator program 30 of FIG. 1 may be used to calculate the periodic repayment amount as described above. During a step 110, funds in the amount of the periodic repayment amount are periodically transmitted from the user account of the second user to the user account of the first user. During the finds transmission, the user balance of the user account of the second user is decreased by the amount of the periodic repayment amount, and the user balance of the user account of the first user is increased by the amount of the periodic repayment amount.

While the invention has been described with reference to at least one preferred embodiment, it is to be clearly understood by those skilled in the art that the invention is not limited thereto. Rather, the scope of the invention is to be interpreted only in conjunction with the appended claims.

1-7. (canceled)

8. A computer-implemented system for facilitating and documenting loans between known individuals, the system comprising:
a host computer operatively connected to receive communications from user computers via a network;
a loan database for storing loan information for loans instituted via the system, wherein loan information includes a loan amount, a loan term, and an interest rate;
means for storing user accounts for users, wherein a user can comprise either or both of a lender or borrower, and wherein a user account is associated with one or more financial accounts of the user;
means for receiving a loan offer document from a first user, the loan offer document including loan information and a designation of a known second user to whom a loan offer is to be made;
means for sending an electronic message from the system to the second user regarding the loan offer;
means for presenting to the second user, via the system, information regarding the loan offer;
means for receiving instructions from the second user regarding whether the second user desires to accept or reject the loan offer; and
means, responsive to an indication of acceptance of the loan offer by the second user, for storing in the loan database the loan information specified in the loan offer document.

9. The system of claim 8, further comprising means for transferring funds for the loan amount from a financial account associated with the first user to a financial account associated with the second user.

10. The system of claim 8, wherein each user account includes a user name, user balance information, and electronic mail address information.

11. The system of claim 8, wherein the first user and second user are each identified by a unique user identifier.

12. The system of claim 11, wherein the unique user identifier is an electronic mail address.

13. The system of claim 11, wherein the unique user identifier of the second user is used to direct a transfer of funds for the loan amount from a financial account associated with the first user to a financial account associated with the second user.

14. The system of claim 8, wherein a financial account associated with the first user is an account maintained at a bank.

15. The system of claim 8, wherein a financial account associated with the second user is an account maintained at a bank.

16. The system of claim 8, wherein a financial account associated with the first user and a financial account associated with the second user are each accounts maintained at a bank.

17. The system of claim 8, wherein a financial account associated with the first user is an account maintained by the host computer.

18. The system of claim 8, wherein a financial account associated with the second user is an account maintained by the host computer.

19. The system of claim 8, wherein a financial account associated with the first user and a financial account associated with the second user are each accounts maintained by the host computer.

20. The system of claim 8, wherein a financial account associated with the first user is maintained by the host computer, and wherein one or more additional accounts are linked to the financial account associated with the first user.

21. The system of claim 20, further comprising means for transferring funds for the loan amount from one of the one or more additional accounts linked to the financial account associated with the first user to a financial account associated with the second user.

22. The system of claim 8, wherein a financial account associated with the second user is maintained by the host computer, and wherein one or more additional accounts are linked to the financial account associated with the second user.

23. The system of claim 22, further comprising means for transferring funds for the loan amount from a financial account associated with the first user to one of the one or more additional accounts linked to the financial account associated with the second user.

24. The system of claim 8, wherein the first user specifies a unique user identifier for the second user, and wherein the unique user identifier for the second user is used to direct a transfer of funds for the loan amount from a financial account associated with the first user to a financial account associated with the second user.

25. The system of claim 8, wherein the first user specifies an electronic mail address for the second user, and wherein the electronic mail address for the second user is used to direct a transfer of funds for the loan amount from a financial account associated with the first user to a financial account associated with the second user.

26. The system of claim 8, further comprising means for enabling the first user to specify a repayment option for the loan offer.

27. The system of claim 26, wherein the repayment option is specified by the first user at the time the loan offer is made.

28. The system of claim 26, wherein the repayment option comprises an option to transfer funds from a financial account associated with the second user to a financial account associated with the first user.

29. The system of claim 28, wherein either or both of the financial account associated with the second user and the financial account associated with the first user comprise accounts maintained at a bank.

30. The system of claim 26, wherein the repayment option comprises an option to periodically and automatically transfer funds, in calculated periodic repayment amounts, from a financial account associated with the second user to a financial account associated with the first user.

31. The system of claim 30, wherein either or both of the financial account associated with the second user and the financial account associated with the first user comprise accounts maintained at a bank.

32. The system of claim 26, wherein the repayment option comprises an option to request, from the second user, an authorization of a transfer of funds from a financial account associated with the second user to a financial account associated with the first user.

33. The system of claim 26, wherein the repayment option comprises an option to transmit, to the second user, a reminder to transfer funds from a financial account associated with the second user to a financial account associated with the first user.

34. The system of claim 8, further comprising means for enabling the first user to specify a collection option for the loan offer.

35. The system of claim 34, wherein the collection option is specified by the first user at the time the loan offer is made.

36. The system of claim 34, wherein the collection option comprises an option to transmit, to the second user, a notification that a financial account associated with the second user has insufficient funds to cover a repayment amount at a predetermined repayment time.

37. The system of claim 34, wherein the collection option comprises an option to transmit, to the second user, a notification that a financial account associated with the second user has insufficient funds to cover a repayment amount at a predetermined repayment time, followed by a notification to a collections agency.

38. The system of claim 34, wherein the collection option comprises an option to transmit, to a collections agency, a notification that a financial account associated with the second user has insufficient funds to cover a repayment amount at a predetermined repayment time.

39. The system of claim 8, wherein the second user need not have a user account with the system prior to receiving the electronic message regarding the loan offer.

40. The system of claim 8, further comprising means for enabling a second user to create a user account with the system prior to accepting the loan offer if the second user has no user account.

41. The system of claim 8, further comprising means for enabling a first user to display a list of linked accounts and a list of outstanding loans initiated by the first user via the system.

42. The system of claim 41, wherein the linked accounts include savings accounts and checking accounts.

43. The system of claim 8, wherein an overdraft on a financial account associated with a user results in drawing funds from another financial account associated with the user.

44. The system of claim 8, wherein an overdraft of a financial account associated with the second user occurring at a predetermined repayment time results in funds being drawn from one or more other accounts associated with the second user.

45. A computer-implemented method for facilitating and documenting loans between known individuals, comprising:
receiving, at a host computer, a loan offer document from a first user, the loan offer document including:
(i) loan information including a loan amount, a loan term, and an interest rate; and
(ii) a designation of a known second user to whom a loan offer is to be made;
sending an electronic message to the second user regarding the loan offer;
presenting, to the second user, information regarding the loan offer;
receiving instructions from the second user regarding whether the second user desires to accept or reject the loan offer; and
storing the loan information specified in the loan offer document in response to an indication of acceptance of the loan offer by the second user.

46. A computer-implemented system for facilitating and documenting loans between known individuals, the system comprising:
a host computer operatively connected to receive communications from user computers via a network;
a loan database for storing loan information for loans instituted via the system, wherein loan information includes a loan amount, a loan term, and an interest rate;
means for storing user accounts for lender users and borrower users;
means for enabling a lender user to initiate a loan process, via the system, by requesting a loan offer document from the host computer;
means for receiving, from the lender user, a loan offer document for a loan offer, the loan offer document including loan information and a designation of a known borrower user to whom the loan offer is to be made;
means for sending an electronic message from the system to the designated borrower user regarding the loan offer;
means for presenting to the borrower user, via the system, information regarding the loan offer;
means for receiving instructions from the borrower user regarding whether the borrower user desires to accept or reject the loan offer; and
means, responsive to an indication of acceptance of the loan offer by the borrower user, for storing in the loan database the loan information specified in the loan offer document.

47. A computer-implemented method for facilitating and documenting loans between known individuals, comprising:
receiving, at a host computer, a request from a lender user for a loan offer document to initiate a loan process;
receiving, at the host computer, the loan offer document from the lender user for a loan offer, the loan offer document including:
(i) loan information including a loan amount, a loan term, and an interest rate; and
(ii) a designation of a known borrower user to whom the loan offer is to be made;
sending an electronic message to the designated borrower user regarding the loan offer;
presenting, to the borrower user, information regarding the loan offer;
receiving instructions from the borrower user regarding whether the borrower user desires to accept or reject the loan offer; and
storing the loan information specified in the loan offer document in response to an indication of acceptance of the loan offer by the borrower user.

48. A computer-implemented system for facilitating and documenting loans between known individuals, the system comprising:
a loan database for storing loan information for loans instituted via the system, wherein loan information includes a loan amount, a loan term, and an interest rate;
means for storing bank account information for lender users and borrower users;
means for receiving, from a lender user, a request to initiate a loan process through the system;
means for receiving a loan offer document from the lender user for a loan offer, the loan offer document including loan information and a designation of a known borrower user to whom the loan offer is to be made;
means for receiving instructions from the borrower user regarding whether the borrower user desires to accept or reject the loan offer;
means, responsive to an indication of acceptance of the loan offer by the borrower user, for storing in the loan database the loan information specified in the loan offer document; and
means for transferring funds for the loan amount from a lender user bank account to a borrower user bank account.

49. A computer-implemented method for facilitating and documenting loans between known individuals, comprising:
receiving, from a lender user, a request for a loan offer document to initiate a loan process;
receiving the loan offer document from the lender user for a loan offer, the loan offer document including:
(i) loan information including a loan amount, a loan term, and an interest rate; and
(ii) a designation of a known borrower user to whom the loan offer is to be made;
receiving instructions from the borrower user regarding whether the borrower user desires to accept or reject the loan offer;
storing the loan information specified in the loan offer document in response to an indication of acceptance of the loan offer by the borrower user; and
transferring funds for the loan amount from a lender user bank account to a borrower user bank account.
